(19) United States
(12) Patent Application Publication
(10) Pub. No.: US 2026/0103417 A1
(43) Pub. Date: Apr. 16, 2026

(54) METHOD FOR THE TREATMENT OF ORGANIC WASTE

(71) Applicant: SUEZ INTERNATIONAL, Puteaux (FR)

(72) Inventors: Pierre-Emmanuel PARDO, Paris La Défense Cedex (FR); Safwan AL AYOUBI, Paris La Défense Cedex (FR)

(73) Assignee: SUEZ INTERNATIONAL, Puteaux (FR)

(21) Appl. No.: 19/112,293

(22) PCT Filed: Sep. 28, 2023
(86) PCT No.: PCT/EP2023/076992

§ 371 Date: Mar. 17, 2025

(30) Foreign Application Priority Data
Sep. 29, 2022 (FR) FR2209945

(51) Int. Cl. C02F 11/18; C02F 11/04; C02F 103/20

(52) U.S. Cl. CPC C02F 11/18; C02F 11/04; C02F 2103/20; C02F 2303/10

(57) ABSTRACT

A method for hydrotreating a mixture M1 comprising at least organic material. The method involves pressurizing mixture M1 comprising at least organic material in order to obtain a mixture stream M1p. Then, water is injected at a temperature of at least 374° C. into the mixture stream M1p at an angle ranging from 15° to 90° to obtain a stream M2 comprising water and organic material. Next, stream M2 is introduced into a hydrotreatment reactor, the hydrotreatment reactor being maintained at a temperature ranging from 150° C. to 430° C., in order to obtain a stream M3 containing hydrotreated organic material.

### TECHNICAL FIELD OF THE INVENTION

The invention relates to the field of biomass treatment, in particular sewage sludge, food and agri-food waste, manure digestate and agricultural residues.

### TECHNICAL BACKGROUND

Hydrothermal treatments of biomass are becoming increasingly common. They require high temperatures. It is therefore essential to control the temperatures in order to achieve the desired hydrothermal biomass treatment quality.

Controlling the temperatures and residence times of the method is thus extremely important to achieve the desired result. Temperatures that are too high or too low, or residence times that are too short or too long either prevent the desired reactions from taking place or lead to undesired secondary reactions resulting in an overall deterioration in desired performance, or worse, in the production of a residue with high processing costs.

In particular, the heating step of hydrothermal treatments is a major cause of these secondary reactions due to the long residence time at intermediate temperatures which can lead to the formation of unwanted compounds such as oils, tars or coal-like derivatives. The longer this heating step takes, the higher the temperatures to be reached, in particular when the temperatures to be reached are close to or higher than the supercritical water temperature.

Furthermore, in the state of the art, heating is often carried out via a “tube in tube” type exchanger to recover heat from the stream (or product) exiting the hydrothermal treatment reactor in order to reduce the amount of heat required for the process. However, in this type of exchanger, the low thermal conduction of the product to be heated results in a very wide variation in temperature inside the product and therefore different process conditions between the different parts of the product leading to unwanted parasitic reactions.

There is therefore a need to provide a method for hydrotreating a biomass-type mixture, allowing improved heat exchange and less formation of unwanted compounds such as oils, tars or coal-like derivatives.

### SUMMARY OF THE INVENTION

The invention relates to a method for hydrotreating a mixture M1 comprising at least organic material, said method comprising:
a) pressurizing mixture M1 comprising at least organic material in order to obtain a mixture stream M1p,
b) injecting water at a temperature of at least 374° C. into the mixture stream M1p at an angle ranging from 15° to 90° to obtain a stream M2 comprising water and organic material,
c) introducing stream M2 into a hydrotreatment reactor, said hydrotreatment reactor being maintained at a temperature ranging from 150° C. to 430° C., in order to obtain a stream M3 containing hydrotreated organic material.

According to one embodiment, the water injected in step b) is at a pressure of at least 225 bar, the method then optionally comprising a step of pressurizing the water to a pressure of at least 225 bar.

According to one embodiment, mixture M2 is introduced into a static turbulator before being introduced into the hydrotreatment reactor, said static turbulator being preferably selected from a propeller, blades, one or more elbows, or combinations thereof.

According to one embodiment, the method further comprises:
at least one heat exchange step X1 allowing heat to be recovered from stream M3 in order to at least partially heat the water to be injected in step b), a cooled stream M3′ then being obtained, and optionally comprising at least one additional water heating step, downstream of the heat exchange X1 allowing the water to be heated to the temperature of at least 374° C. prior to its injection in step b), and
optionally at least one heat exchange step X2 to recover heat from stream M3′ to heat mixture M1p upstream of the injection of water in step b), a cooled stream M3″then being obtained.

According to one embodiment, the method further comprises:
at least one step of cooling at least one fraction of stream M3′ or where applicable stream M3″ to obtain steam and stream M4 comprising hydrotreated organic material, and
a step of injecting at least part of said steam to preheat mixture M1 upstream of pressurization step a).

According to one embodiment, mixture M1 is preheated upstream of pressurization step a) to a temperature ranging from 50 to 160° C., preferentially from 50 to 90° C.

Preferably, the cooling of at least one fraction of stream M3′ or where applicable of at least one fraction of stream M3″ is carried out at a regulated pressure based on the preheating temperature of mixture M1 upstream of pressurization step a).

According to one embodiment, the method further comprises a step of cooling at least one fraction of stream M4 to obtain stream M4′ and at least one digestion step carried out on at least one fraction of stream M4′.

According to one embodiment, mixture M1p during the injection of water in step b) is at a temperature ranging from 90° C. to 300° C., preferably from 90 to 170° C.

According to one embodiment, the method further comprises a step of injecting water at a temperature of at least 374° C. directly into the hydrotreatment reactor, said water preferably being at the same temperature and at the same pressure as the water injected in step b).

Preferably, stream M3 comprising hydrotreated organic material is recovered via an outlet in the upper part of the reactor, said reactor further comprising an outlet in the lower part of the reactor.

Preferably, stream M3 comprising the hydrotreated organic material exiting the reactor can undergo one or more further post-treatment steps, said further step(s) being carried out where applicable upstream of heat exchanges X1 and X2.

The invention also relates to an installation for implementing the hydrotreatment method according to the invention, said installation comprising:
a feed line for mixture M1,
a pressurization pump 2 supplied by the feed line for mixture M1 and comprising an outlet line for mixture M1p,
a device for injecting water ES at an angle ranging from 15° to 90° into the line of mixture M1p downstream of the pressurization pump 2,
a feed line for stream M2 downstream of the water injection device ES and upstream of the hydrotreatment reactor,
a hydrotreatment reactor 1 comprising at least one inlet for introducing at least one fraction of stream M2 and at least one outlet for extracting stream M3.

According to one embodiment, the installation according to the invention further comprises:
A static turbulator 10 supplied by stream M2, said static turbulator being located upstream or at the inlet of the hydrotreatment reactor 1, and
a heat exchanger 6 downstream of the hydrotreatment reactor 1, said heat exchanger recovering heat from stream M3 to obtain stream M3′ and transferring this heat to the water upstream of the water injection device ES, and
optionally a water heating device 7, downstream of the heat exchanger 6 and upstream of the water injection device ES.

According to one embodiment, the installation according to the invention further comprises:
Optionally a heat exchanger 8 for recovering heat from mixture M3′ to obtain mixture M3″ and for transferring this heat to mixture M1p upstream of the water injection device ES,
A cooling device 4 supplied by at least one fraction of stream M3′ or where applicable M3″ to produce steam and a cooled stream M4,
A device 3 for injecting said produced steam into the stream of mixture M1 upstream of the pressurization pump 2,
Optionally a cooling device 9 downstream of the cooling device 4 supplied by at least one fraction of stream M4 for cooling at least one fraction of stream M4 to obtain stream M4′, and
Optionally a digester 5 supplied by stream M4′.

The invention thus allows the biomass to be brought up to temperature very quickly by direct heating which in turn allows the desired process conditions to be controlled.

The invention also allows the biomass to be brought to a uniform temperature by virtue in particular of a static mixer which also allows the desired process conditions to be controlled.

Finally, the invention allows the method to maintain thermal recovery by heating the water under supercritical conditions in order to minimize the overall thermal consumption of the method.

Biomass has a certain viscosity. However, viscosity makes heat exchange difficult. The viscosity of water is lower than that of any biomass, therefore heating water will result in a smaller recovery exchanger and therefore lower cost.

The invention proposes injecting supercritical water directly into the stream of organic material M1. Thus, the thermal shock between the organic material M1, part of which is cellular content and the very hot supercritical water will cause local cavitations due to the difference in local density and therefore local pressure. These cavitations allow an immediate release of the cell contents into the aqueous matrix and therefore subsequently the immediate reaction of the proteins and sugars contained in the bacteria in the hydrotreatment reactor.

### BRIEF DESCRIPTION OF THE FIGURES

FIG. 1 shows an installation according to one embodiment of the method according to the invention.

FIG. 2 shows an installation according to one embodiment of the method according to the invention.

FIG. 3 shows an installation according to one embodiment of the method according to the invention.

FIG. 4 shows an installation according to one embodiment of the method according to the invention.

FIG. 5 shows an installation according to one embodiment of the method according to the invention.

FIG. 6 shows an installation according to one embodiment of the method according to the invention.

### DETAILED DESCRIPTION OF THE INVENTION

The invention relates to the hydrothermal treatment of mixture M1 comprising organic material. Mixture M1 further comprises inorganic material.

Mixture M1 is typically a biomass. Biomass can be a paste or liquid; it may particularly be sewage sludge, food and agri-food waste, especially manure digestate and agricultural residues.

The present invention relates to a method for hydrotreating a mixture M1 comprising at least organic material, said method comprising:
a. pressurizing mixture M1 comprising at least organic material in order to obtain a stream of mixture M1p,
b. injecting water at a temperature of at least 374° C. into the stream of mixture M1p at an angle ranging from 15° to 90° C. in order to obtain a stream M2 comprising water and organic material,
c. introducing stream M2 into a hydrotreatment reactor, said hydrotreatment reactor being maintained at a temperature ranging from 150° C. to 430° C., in order to obtain a stream M3 containing hydrotreated organic material.

For the purposes of the present invention, the expression “at least one fraction of a mixture or stream” has the same meaning as the expression “all or part of said mixture or stream”. In the case of a part of said mixture or of said stream, this expression refers to a certain proportion of said mixture or said stream. For example, for the purposes of this expression, “each fraction of the mixture” or “each fraction of the stream” will have the same composition.

For the purposes of the present invention, the expression “where applicable of step X” introduces a feature that is present when step X is present.

For the purposes of the present invention, the expression “where applicable of stream X” introduces a feature that is present when stream X is present.

### Pressurization Step a)

The method according to the invention comprises a step of pressurizing mixture M1 to a pressure ranging from 150 to 350 bar, preferably from 170 to 220 bar, said mixture M1 optionally already being pressurized.

For the pressurization step, a pump may be provided on the line of mixture M1.

Downstream of the pressurization, a stream of mixture M1p is obtained.

### Water Injection Step b)

The method according to the invention comprises a step during which water at a temperature of at least 374° C. is injected into the stream of mixture M1p in order to obtain a stream of mixture M2 comprising water and organic material. Mixture M2 will typically also comprise inorganic material.

Water is injected at an angle ranging from 15° to 90°, preferably from 45° to 90°, or even from 45° to 75°, with respect to the feed line for stream M1p.

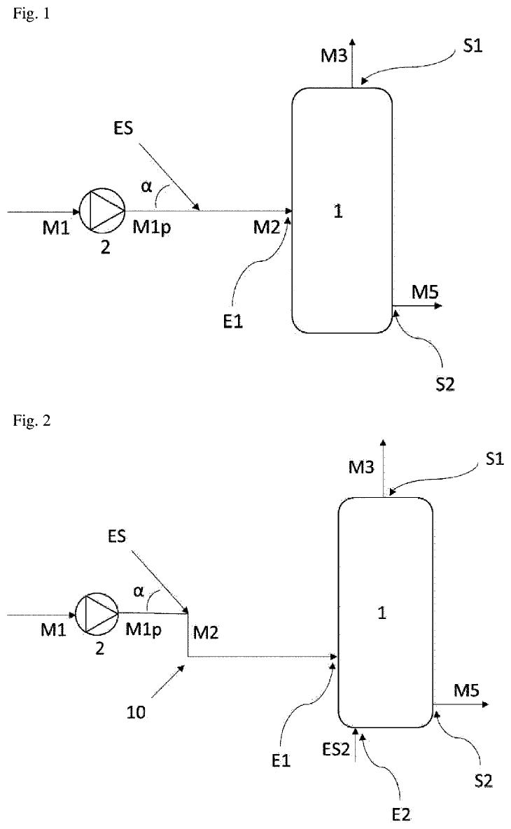

FIG. 1 shows the angle defined in the invention as being the angle (alpha) between the water injection line ES and the feed line for stream M1p.

After the injection of water ES, the line of stream M2 may not be parallel with the line of stream M1p. For example, the line of stream M2 may comprise a turbulator which would consist of one or more changes of direction of the piping prior to entry into the hydrotreatment reactor.

According to one embodiment, mixture M1p during the injection of water in step b) is at a temperature ranging from 90° C. to 300° C., preferably from 90 to 170° C.

Mixture M1p can be heated in one or more steps, for example by heat exchange and/or by external heating.

Upstream of step b), the injected water will typically be at a higher pressure than the pressure of mixture M1p.

According to a preferred embodiment of the invention, the water injected in step b) is at a pressure of at least 225 bar. According to this embodiment, the injected water will then be referred to as “supercritical water”.

According to one embodiment, the method of the invention comprises at least one water heating step to obtain water at the temperature of at least 374° C. upstream to the injection thereof in step b).

According to one embodiment, the method according to the invention comprises a step of pressurizing the water to a pressure of at least 225 bar followed by at least one step of heating the water to obtain water at the temperature of at least 374° C. upstream of the injection thereof in step b).

Preferably, at least one water heating step is implemented by heat exchange with the heat of at least one fraction of stream M3 comprising hydrotreated organic material exiting the hydrotreatment reactor, the stream thus cooled being referred to as stream M3′ at the end of this heat exchange (this could be the heat exchange step X1 described below).

At the injection outlet between the water ES and the sludge M1p, a static turbulator (for example, selected from propellers, blades, pipe bends, or combinations thereof) can also be introduced to increase turbulence and rapid heat exchange between the sludge and the water and prevent the sludge and the water from remaining in separate flows (in order to avoid laminar hydraulic lines).

Thus, according to one embodiment of the invention, upstream of step c), mixture M2 is introduced into a static turbulator, said static turbulator then being located upstream of the reactor or at the inlet of the hydrotreatment reactor.

According to one embodiment, a static turbulator is present upstream or at the inlet of the hydrotreatment reactor in order to increase turbulence in mixture M2.

### Step c)

The method according to the invention comprises a step of introducing stream M2 into a hydrotreatment reactor, optionally after passing through a static turbulator.

The hydrotreatment reactor is advantageously maintained at a temperature ranging from 150° C. to 430° C. For example, the temperature can be maintained by peripheral heat exchange with a hot fluid, by placing the equipment inside a temperature-maintained furnace, or by using an electric heating collar.

Within the context of the method of the invention, the flow rates of the streams of injected water, preferably supercritical water, and mixture M1p are advantageously controlled and will typically allow the new mixture (so-called mixture M2) to have a residence time in the hydrotreatment reactor ranging from 1 minute to 30 minutes, preferably 10 minutes to 15 minutes.

At the outlet of the hydrotreatment reactor, a stream comprising hydrotreated organic material is obtained, stream M3. The method of the invention will typically comprise a step of extracting a stream M3.

Advantageously, the hydrotreatment reactor consists of an outlet for material M5, a so-called non-hydrotreated material. The hydrotreatment reactor can be equipped with a separation device, for example a filter, to obtain a stream enriched with soluble materials (stream M3) and a stream depleted of soluble materials (stream M5), then extract them from the reactor.

For the purposes of this invention, “stream enriched with soluble materials” means a stream comprising a mass proportion of soluble materials greater than the mass proportion of soluble materials in mixture M2.

For the purposes of the present invention, “stream depleted of soluble materials” means a stream comprising a mass proportion of soluble materials less than the mass proportion of soluble materials in mixture M2.

For the purposes of this invention, a soluble material will be a material obtained after filtration through a 40 μm filter (material not retained by said 40 μm filter) and subsequent drying of an initial material.

The filter may comprise one or more filtration layers, which may optionally have different mesh sizes. Preferably, the outer filtration layers have larger mesh sizes than the inner filtration layers.

According to one embodiment, the filter has a mesh size of less than 100 μm, preferably less than 50 μm, even more preferably less than 40 μm. When the filter comprises several filtration layers, the finest mesh size will preferably be less than 100 μm, preferably less than 50 μm, even more preferably less than 40 μm.

According to one embodiment, the method of the invention comprises an extraction of a hydrotreated stream M3 (also known as a stream enriched with soluble materials) and an extraction of a non-hydrotreated stream M5 (also known as a stream depleted of soluble materials). Preferably, according to this embodiment, the entry of mixture M2 is via an inlet E1 of the hydrotreatment reactor, the exit of stream M3 is via an outlet S1 of the hydrotreatment reactor and the outlet of stream M5 is via an outlet S2 of the hydrotreatment reactor. Advantageously, inlet E1 is located at a lower altitude than outlet S1 and at a higher altitude than outlet S2.

According to a particularly advantageous embodiment, the method of the invention further comprises at least one heat exchange step X1 to recover heat from stream M3 (downstream of heat exchange X1, the cooled stream will be referred to as stream M3′) to at least partially heat the water to be injected in step b). Typically, according to this embodiment, the method of the invention further comprises at least one water heating step, downstream of said heat exchange X1, allowing the water to be heated to the temperature of at least 374° C. prior to the injection thereof in step b).

When the method of the invention comprises a heat exchange step X1, said heat exchange step X1 is preferably carried out with water having a pressure of at least 225 bar, thus it will preferably be carried out after a step of pressurizing the water to a pressure of at least 225 bar.

According to one embodiment, the method of the invention further comprises a heat exchange step X2 for recovering heat from stream M3 (preferably from stream M3′ when the first heat exchange X1 is present) to heat mixture M1p upstream of the injection of water in step b) of the method. This heat exchange then results in a cooled stream M3″.

Stream M1p downstream of heat exchange X2 may typically have a temperature ranging from 90 to 170° C.

Stream M3″may typically have a temperature ranging from 100 to 200° C.

Preferably, according to this embodiment, the hydrotreatment method according to the invention further comprises:
a step of cooling at least one fraction of stream M3″ to obtain steam and stream M4 comprising hydrotreated organic material, and
a step of injecting at least part of said steam to preheat mixture M1 upstream of pressurization step a).

The cooling step can be carried out using a cooling device selected from a heat exchanger which may or may not be integrated with a Rankine, flash or scrubber cycle, preferably using a flash.

The steam produced during cooling is, according to this embodiment, used to preheat mixture M1 upstream of pressurization step a).

Preferably, according to this embodiment, mixture M1 is preheated upstream of pressurization step a) to a temperature ranging from 50 to 160° C., preferentially from 50 to 90° C., by virtue of steam from cooling at least one fraction of stream M3″. It should be noted that mixture M1 may optionally already be pressurized, prior to step a) as defined in the invention, step a) will thus increase the pressure of mixture M1.

The invention thus allows better optimization of the viscosity of biomass undergoing high-pressure treatment. Indeed, the difficulty of pumping at these high pressures requires a minimum viscosity of the biomass to be pumped in order to meet the specifications of very high-pressure pumps.

By injecting steam into mixture M1, all of the possibilities are used to reduce the viscosity of the biomass to a value acceptable to pumping technologies, while minimizing biomass dilution which can cause additional costs in downstream equipment sizing (residence times to be respected, etc.).

According to one embodiment, the cooling of at least one fraction of stream M3′ or where applicable M3″ is carried out at a regulated pressured based on the preheating temperature of mixture M1 upstream of pressurization step a).

Indeed, the pressure and the temperature are linked for saturated steam. Maintaining a constant pressure makes it possible to control the temperature of the steam and therefore the maximum temperature that can be reached by the product heated by the steam (mixture M1 in the case of the invention).

For example, the pressure can be maintained between 2 and 10 bar.

According to one embodiment, the method according to the invention further comprises an additional step of cooling at least one fraction of stream M4 comprising hydrotreated organic material to obtain a stream M4′ followed by a step of introducing said stream M4′ into a digester to allow digestion of the organic material contained in stream M4′.

The additional cooling step for example cools stream M4 to a temperature less than or equal to 100° C., preferably less than or equal to 60° C., more preferably less than or equal to 40° C.

According to one embodiment, cooled stream M4′ is then introduced into a digester to undergo a digestion step.

The digestion can be implemented according to any digestion method known to the person skilled in the art.

According to one embodiment, the treatment method according to the invention comprises at least one anaerobic digestion step carried out on at least one fraction of stream M4′, preferably all of stream M4′.

Anaerobic digestion may be mesophilic or thermophilic.

When mesophilic digestion is used, the temperature in the digester ranges from 33° C. to 37° C. and the residence time is 16 to 22 days.

When thermophilic digestion is used, the temperature in the digester ranges from 55° C. to 60° C. and the residence time is 10 to 12 days.

Residence time and temperature are two factors influencing the proper degradation of sludge and therefore the optimization of energy production.

When the stream to be digested is sufficiently liquid, digestion can be of the UASB type and residence times reduced.

At the end of the digestion step, a biogas is obtained.

This biogas typically comprises a mixture substantially consisting of methane, carbon dioxide and water. The biogas may optionally comprise other gases, such as hydrogen, oxygen, nitrogen, hydrogen sulfide, but these other gases collectively represent less than 10% by weight of the biogas, of the total weight of the biogas.

According to one embodiment, the method according to the invention further comprises one or more steps of preheating mixture M1p, to a temperature ranging for example from 90° C. to 300° C., preferably from 90° C. to 170° C. At least one preheating step may for example be carried out by heat exchange X2 with the heat present in stream M3′, said stream M3′ being obtained after a first heat exchange X1 implemented on stream M3 comprising hydrotreated organic material resulting from step c). Such a heat exchange step X2 can be combined with another external heating step to heat mixture M1p to the desired temperature.

According to one embodiment, the method according to the invention further comprises a (further) step of injecting water ES2 at a temperature of at least 374° C. directly into the hydrotreatment reactor, a step referred to as step d).

Preferably, said water for this further injection directly into the hydrotreatment reactor is at the same temperature and at the same pressure as the water injected in step b) of the method of the invention. According to one embodiment, this water ES2 injected into the reactor is obtained by the same method as that described for the water injected in step b) (advantageously heat exchange X1 followed by additional heating). This minimizes the equipment and energy requirements.

Preferably, water ES and water ES2 are supercritical water (temperature of at least 374° C. and pressure of at least 225 bar).

Typically, according to this embodiment, the hydrotreatment reactor will comprise, in addition to the inlet for introducing stream M2, a second inlet E2 for introducing water ES2 (water at a temperature of at least 374° C.). Said second inlet E2 is preferably located at the bottom of the reactor. More specifically, if stream M2 is introduced via an inlet E1 at the upper part of the hydrotreatment reactor, then water ES2 will preferably be introduced via an inlet E2 at the lower part of the hydrotreatment reactor.

According to one embodiment, water ES2 is introduced into the hydrotreatment reactor in a vertical direction, preferably in an upward direction with respect to gravity.

According to one embodiment, stream M3 comprising hydrotreated organic material is recovered via an outlet in the upper part of the reactor, said reactor further comprising an outlet in the lower part of the reactor.

For the purposes of the present invention, the term “lower part” is used in contrast to “upper part”. Thus, an outlet in the upper part will be at a higher altitude than the outlet in the lower part. Similarly, an outlet in the upper part will be at a higher altitude than an inlet in the lower part.

According to one embodiment, water is injected directly into the reactor via an inlet E2 in the lower part of the reactor, while stream M3 preferably exits via an outlet S1 in the upper part of the reactor.

Thus, according to one embodiment implementing an injection of water ES2 and an extraction of non-hydrotreated material (depleted of soluble material), then preferably with respect to the hydrotreatment reactor, the inlet E1 of material M2 is located at a lower altitude than the outlet S1 of material M3 and the inlet E1 of material M2 is located at a higher altitude than the outlet S2 of material M5 and higher than the inlet E2 of water ES2. This configuration thus optimizes residence times and promotes solubilization of the material in the reactor.

According to one embodiment, at least one fraction of stream M3 comprising the hydrotreated organic matter exiting the reactor is sent to one or more post-treatment steps.

Among the post-treatments that can be implemented are a supplementary heating step and a hydrothermal gasification step. According to this embodiment, the heat exchange(s) (X1, X2) described in the present invention and the digestion described in the invention will be carried out where applicable, downstream of said post-treatments.

According to one embodiment, the hydrotreatment method of the invention comprises:
a) pressurizing mixture M1, said mixture M1 optionally being pressurized, said mixture M1 comprising at least organic material, in order to obtain a stream of pressurized mixture M1p,
b) injecting water at a temperature of at least 374° C. and at a pressure of at least 225 bar into the stream of mixture M1p at an angle ranging from 45° to 75° to obtain a stream M2 comprising water and organic material,
c) introducing stream M2 into a hydrotreatment reactor, said hydrotreatment reactor being maintained at a temperature ranging from 150° C. to 430° C., in order to obtain a stream M3 containing hydrotreated organic material,
said method further comprising:
a step of pressurizing water to a pressure of at least 225 bar,
a heat exchange step X1 downstream of said water pressurization, allowing heat to be recovered from stream M3 to at least partially heat the water to be injected in step b) and, where applicable, the water ES2 to be injected in step
d), allowing a cooled stream M3′ and a stream of heated water W2 to be obtained downstream of exchange X1,
an additional heating step carried out on the stream of heated water W2, downstream of said heat exchange X1, allowing water W2 to be heated to the temperature of at least 374° C. before being injected in step b) and where applicable water ES2 to be injected in step d),
a heat exchange step X2, downstream of heat exchange X1, allowing heat to be recovered from stream M3′ to heat mixture M1p upstream of the injection of water in step b) of the method and where applicable water ES2 to be injected in step d) of the method, this heat exchange X2 then making it possible to obtain a cooled stream M3″.

According to one embodiment, the hydrotreatment method of the invention comprises:
a) pressurizing mixture M1, said mixture M1 optionally being pressurized, said mixture M1 comprising at least organic material, in order to obtain a stream of pressurized mixture M1p,
b) injecting water at a temperature of at least 374° C. and at a pressure of at least 225 bar into the stream of mixture M1p at an angle ranging from 15° to 90° to obtain a stream M2 comprising water and organic material,
c) introducing stream M2 into a hydrotreatment reactor, said hydrotreatment reactor being maintained at a temperature ranging from 150° C. to 430° C., in order to obtain a stream M3 containing hydrotreated organic material,
said method further comprising:
upstream of step c), a step of introducing stream M2 into a static turbulator,
a step of pressurizing water to a pressure of at least 225 bar,
a heat exchange step X1 downstream of said water pressurization, allowing heat to be recovered from stream M3 to at least partially heat the water to be injected in step b) and, where applicable, the water ES2 to be injected in step d), allowing a cooled stream M3′ and a stream of heated water W2 to be obtained downstream of exchange X1,
an additional heating step carried out on the stream of heated water W2, downstream of said heat exchange X1, allowing water W2 to be heated to the temperature of at least 374° C. prior to the injection thereof in step b),
a heat exchange step X2, downstream of heat exchange X1, allowing heat to be recovered from stream M3′ to heat mixture M1p upstream of the injection of water in step b) of the method and where applicable water ES2 to be injected in step d) of the method, this heat exchange X2 then making it possible to obtain a cooled stream M3″.

According to one embodiment, the hydrotreatment method of the invention comprises:
a) pressurizing mixture M1, said mixture M1 optionally being pressurized, said mixture M1 comprising at least organic material, in order to obtain a stream of pressurized mixture M1p,
b) injecting water at a temperature of at least 374° C. and at a pressure of at least 225 bar into the stream of mixture M1p at an angle ranging from 45° to 75° to obtain a stream M2 comprising water and organic material,
c) introducing stream M2 into a hydrotreatment reactor, said hydrotreatment reactor being maintained at a temperature ranging from 150° C. to 430° C., in order to obtain a stream M3 containing hydrotreated organic material, said method further comprising:
upstream of step c), a step of introducing stream M2 into a static turbulator,
a step of pressurizing water to a pressure of at least 225 bar,
a heat exchange step X1 downstream of said water pressurization, allowing heat to be recovered from stream M3 to at least partially heat the water to be injected in step b) and, where applicable, the water ES2 to be injected in step d), allowing a cooled stream M3′ and a stream of heated water W2 to be obtained downstream of exchange X1,
an additional heating step carried out on the stream of heated water W2, downstream of said heat exchange X1, allowing water W2 to be heated to the temperature of at least 374° C. before being injected in step b) and where applicable water ES2 to be injected in step d),
a heat exchange step X2, downstream of heat exchange X1, allowing heat to be recovered from stream M3′ to heat mixture M1p upstream of the injection of water in step b) of the method and where applicable water ES2 to be injected in step d) of the method, this heat exchange X2 then making it possible to obtain a cooled stream M3″.

According to one embodiment, the hydrotreatment method of the invention comprises:
a) pressurizing mixture M1, said mixture M1 optionally being pressurized, said mixture M1 comprising at least organic material, in order to obtain a stream of pressurized mixture M1p,
b) injecting water at a temperature of at least 374° C. and at a pressure of at least 225 bar into the stream of mixture M1p at an angle ranging from 45° to 75° to obtain a stream M2 comprising water and organic material,
c) introducing stream M2 into a hydrotreatment reactor, said hydrotreatment reactor being maintained at a temperature of at least 150° C. to 430° C., in order to obtain a stream M3 comprising hydrotreated organic material,
said method further comprising:
a step of pressurizing water to a pressure of at least 225 bar,
a heat exchange step X1 downstream of said water pressurization, allowing heat to be recovered from stream M3 to at least partially heat the water to be injected in step b) and, where applicable, the water ES2 to be injected in step d), allowing a cooled stream M3′ and a stream of heated water W2 to be obtained downstream of exchange X1,
an additional heating step carried out on the stream of heated water W2, downstream of said heat exchange X1, allowing water W2 to be heated to the temperature of at least 374° C. prior to the injection thereof in step b),
a heat exchange step X2, downstream of heat exchange X1, allowing heat to be recovered from stream M3′ to heat mixture M1p upstream of the injection of water in step b) of the method and where applicable water ES2 to be injected in step d) of the method, this heat exchange X2 then making it possible to obtain a cooled stream M3″
a step of cooling at least one fraction of stream M3″ to obtain steam and stream M4 comprising hydrotreated organic material, and
a step of injecting at least part of said steam to preheat mixture M1 upstream of pressurization step a).

According to one embodiment, the hydrotreatment method of the invention comprises:
a) pressurizing mixture M1, said mixture M1 optionally being pressurized, said mixture M1 comprising at least organic material, in order to obtain a stream of pressurized mixture M1p,
b) injecting water at a temperature of at least 374° C. and at a pressure of at least 225 bar into the stream of mixture M1p at an angle ranging from 15° to 90° to obtain a stream M2 comprising water and organic material,
c) introducing stream M2 into a hydrotreatment reactor, said hydrotreatment reactor being maintained at a temperature ranging from 150° C. to 430° C., in order to obtain a stream M3 containing hydrotreated organic material,
said method further comprising:
upstream of step c), a step of introducing stream M2 into a static turbulator,
a step of pressurizing water to a pressure of at least 225 bar,
a heat exchange step X1 downstream of said water pressurization, allowing heat to be recovered from stream M3 to at least partially heat water W1 to be injected in step b) and where applicable water ES2 to be injected in step d), allowing a cooled stream M3′ and a stream of heated water W2 to be obtained downstream of exchange X1,
an additional heating step carried out on the stream of heated water W2, downstream of said heat exchange X1, allowing water W2 to be heated to the temperature of at least 374° C. before being injected in step b) and where applicable water ES2 to be injected in step d),
a heat exchange step X2, downstream of heat exchange X1, allowing heat to be recovered from stream M3′ to heat mixture M1p upstream of the injection of water in step b) of the method and where applicable water ES2 to be injected in step d) of the method, this heat exchange X2 then making it possible to obtain a cooled stream M3″
a step of cooling at least one fraction of stream M3″ to obtain steam and stream M4 comprising hydrotreated organic material, and
a step of injecting at least part of said steam to preheat mixture M1 upstream of pressurization step a).

According to one embodiment, the hydrotreatment method of the invention comprises:
a) pressurizing mixture M1, said mixture M1 optionally being pressurized, said mixture M1 comprising at least organic material, in order to obtain a stream of pressurized mixture M1p,
b) injecting water at a temperature of at least 374° C. and at a pressure of at least 225 bar into the stream of mixture M1p at an angle ranging from 45° to 75° to obtain a stream M2 comprising water and organic material,
c) introducing stream M2 into a hydrotreatment reactor, said hydrotreatment reactor being maintained at a temperature ranging from 150° C. to 430° C., in order to obtain a stream M3 containing hydrotreated organic material,
said method further comprising:
upstream of step c), a step of introducing stream M2 into a static turbulator,
a step of pressurizing water to a pressure of at least 225 bar,
a heat exchange step X1 downstream of said water pressurization, allowing heat to be recovered from stream M3 to at least partially heat water W1 to be injected in step b) and where applicable water ES2 to be injected in step d), allowing a cooled stream M3′ and a stream of heated water W2 to be obtained downstream of exchange X1,
an additional heating step carried out on the stream of heated water W2, downstream of said heat exchange X1, allowing water W2 to be heated to the temperature of at least 374° C. before being injected in step b) and where applicable water ES2 to be injected in step d),
a heat exchange step X2, downstream of heat exchange X1, allowing heat to be recovered from stream M3′ to heat mixture M1p upstream of the injection of water in step b) of the method and where applicable water ES2 to be injected in step d) of the method, this heat exchange X2 then making it possible to obtain a cooled stream M3″.
a step of cooling at least one fraction of stream M3″ to obtain steam and stream M4 comprising hydrotreated organic material, and
a step of injecting at least part of said steam to preheat mixture M1 upstream of pressurization step a).

The invention also relates to an installation for implementing the hydrotreatment method according to the invention.

The installation according to the invention comprises:
a feed line for mixture M1, optionally pressurized,
a pressurization pump 2 supplied by the feed line for mixture M1 and comprising an outlet line for mixture M1p,
a device for injecting water ES at an angle ranging from 15° to 90° into the line of mixture M1p downstream of the pressurization pump 2, a stream of mixture M2 is then obtained,
a feed line for stream M2 downstream of the water injection device ES and upstream of the hydrotreatment reactor,
a hydrotreatment reactor 1 comprising at least one inlet E1 and at least one outlet S1 for stream M3.

According to one embodiment, the hydrotreatment reactor 1 further comprises at least one outlet S2 for stream M5 and/or at least one inlet E2 for introducing water directly into the reactor 1. Preferably, inlet E1 is located at a lower altitude than outlet S1, even more preferably inlet E1 is located at a higher altitude than outlet S2, advantageously outlet S1 is at a higher altitude than inlet E2. This configuration improves residence times and solubilization of the material in the reactor.

FIGS. 1 to 6 show embodiments of installations for carrying out the method according to the invention.

The installation of FIG. 1 comprises the feed line for mixture M1, the pressurization pump 2, the feed line or supercritical water ES via an alpha angle in the line for mixture M1p downstream of the pressurization pump 2, and the hydrotreatment reactor 1 comprising an outlet S1 for stream M3 and an outlet S2 for the non-hydrotreated material M5.

According to one embodiment, the installation further comprises a static turbulator 10 supplied by the line of stream M2, said static turbulator being upstream or at the inlet of the hydrotreatment reactor 1. The mixture exiting the turbulator 10 can thus supply the hydrotreatment reactor 1. This embodiment is shown in FIG. 2 and FIG. 6.

The static turbulator can be selected from a propeller, blades or elbows, or combinations thereof. Thus, for example, the feed line for the stream of mixture M2 located between the water injection device ES and the hydrotreatment reactor 1 may comprise one or more elbows allowing turbulence to be added, thus improving exchanges between the water and the sludge.

As shown in FIG. 2, the turbulator 10 may comprise elbows.

According to one embodiment, the hydrotreatment reactor 1 comprises a separation device, for example one or more filters.

The filter may comprise one or more filtration layers, which may optionally have different mesh sizes. Preferably, the outer filtration layers have larger mesh sizes than the inner filtration layers.

According to one embodiment, the filter has a mesh size of less than 100 μm, preferably less than 50 μm, even more preferably less than 40 μm. When the filter comprises several filtration layers, the finest mesh size will preferably be less than 100 μm, preferably less than 50 μm, even more preferably less than 40 μm.

According to one embodiment shown in FIG. 2 to FIG. 6, the installation further comprises a water injection device ES2 for injecting water directly into the hydrotreatment reactor, via an inlet E2, preferably in the lower part of the reactor, allowing vertical injection from the bottom upwards.

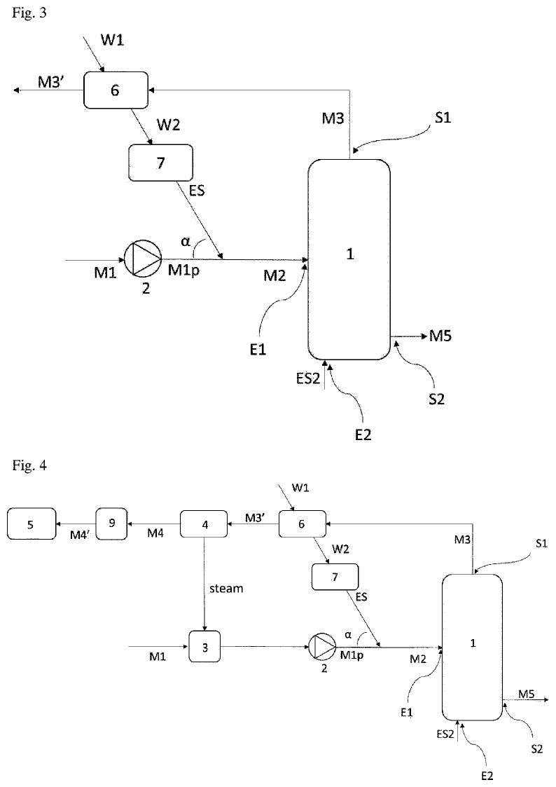

FIG. 3 show an embodiment of the method according to the invention. The installation exemplified in FIG. 3 shows a heat exchange step X1 via a heat exchanger 6. The heat exchanger 6 recovers the heat present in stream M3 exiting the hydrotreatment reactor 1 to transfer it to water W1 in order to preheat the water prior to the injection thereof into stream M1p.

According to one embodiment exemplified in FIG. 3, the installation according to the invention comprises:
a heat exchanger 6 downstream of the hydrotreatment reactor, said heat exchanger 6 recovering heat from stream M3 to obtain a cooled stream M3′ and transferring this heat to water W1 upstream of the water injection device ES to obtain a stream of heated water W2,
a water heating device 7, downstream of heat exchanger 6 and upstream of water injection device ES, said heating device 7 being supplied with water W2 and allowing water ES to be obtained at a temperature of at least 374° C.

According to an embodiment not shown, the installation comprises a pressurization pump on the water feed line W1 upstream of the heat exchanger 6, advantageously allowing the water to be pressurized to at least 225 bar.

According to an advantageous embodiment, when the installation comprises a water injection device ES2, the installation further comprises a water feed line connecting the heat exchanger 6 or where applicable the heat exchanger 7 to the water injection device ES2.

FIG. 4 shows an embodiment of the method according to the invention. The installation exemplified in FIG. 4 comprises:
a heat exchanger 6 downstream of the hydrotreatment reactor 1, said heat exchanger recovering heat from stream M3 to obtain a stream M3′ and transferring this heat to water W1 upstream of the heating device 7, to obtain heated water W2,
a water heating device 7, downstream of the heat exchanger 6 supplied with heated water W2 and upstream of the water injection device ES,
a cooling device 4 supplied by at least one fraction of stream M3′ to produce steam and a cooled stream M4,
a device 3 for injecting said produced steam into the stream of mixture M1 upstream of the pressurization pump 2, said injection device 3 can be a reactor,
a cooling device 9 downstream of the cooling device 4 for cooling at least one fraction of stream M4 to obtain a stream M4′, and
a digester 5 supplied by stream M4′.

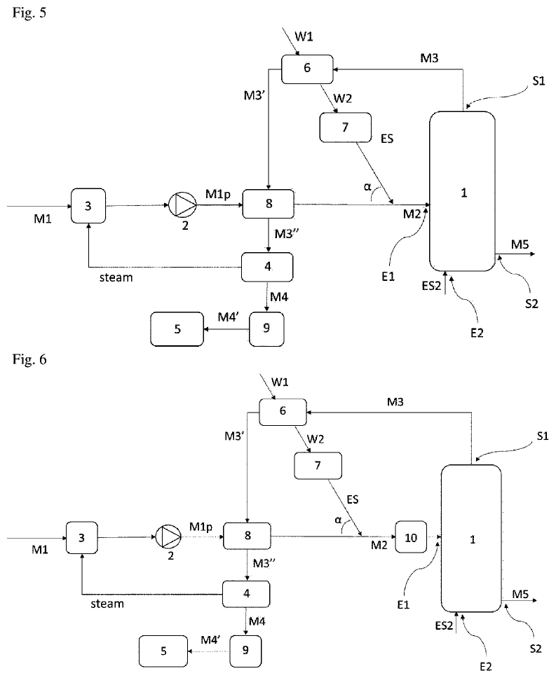

FIG. 5 shows an embodiment of the method according to the invention. The installation shown in FIG. 5 comprises:
a heat exchanger 6 downstream of the hydrotreatment reactor, said heat exchanger recovering heat from stream M3 to obtain a stream M3′ and transferring this heat to water W1 upstream of the heating device 7, to obtain heated water W2,
a water heating device 7, downstream of the heat exchanger 6 supplied with heated water W2 and upstream of the water injection device ES,
a heat exchanger 8 for recovering heat from mixture M3′ to obtain mixture M3″ and for transferring this heat to mixture M1p upstream of the water injection device ES,
a cooling device 4 supplied by at least one fraction of stream M3″ to produce steam and a cooled stream M4,
a device 3 for injecting said produced steam into the stream of mixture M1 upstream of the pressurization pump 2, said injection device 3 can be a reactor,
a cooling device 9 downstream of the cooling device 4 for cooling at least one fraction of stream M4 to obtain a stream M4′, and
a digester 5 supplied by stream M4′.

FIG. 6 differs from FIG. 5 due to the presence of a static turbulator 10.

According to an embodiment not shown in the figures, the installation according to the invention further comprises at least one post-treatment device supplied by at least one fraction of stream M3 downstream of the hydrotreatment reactor 1. When the installation further comprises at least one heat exchanger 6, then said post-treatment device is upstream of said heat exchanger 6. Preferably, said post-treatment device is selected from an additional heating step and a hydrothermal gasification step.

1. A method for hydrotreating a mixture M1 comprising at least organic material, said method comprising:
a) pressurizing mixture M1 comprising at least organic material to obtain a mixture stream M1p;
b) injecting water at a temperature of at least 374° C. into the mixture stream M1p at an angle ranging from 15° to 90° to obtain a stream M2 comprising water and organic material; and
c) introducing stream M2 into a hydrotreatment reactor, said hydrotreatment reactor being maintained at a temperature ranging from 150° C. to 430° C., to obtain a stream M3 containing hydrotreated organic material.

2. The hydrotreatment method according to claim 1, wherein the water injected in step b) is at a pressure of at least 225 bar, the method then optionally comprising a step of pressurizing the water to a pressure of at least 225 bar.

3. The hydrotreatment method according to claim 1, wherein mixture M2 is introduced into a static turbulator before being introduced into the hydrotreatment reactor.

4. The hydrotreatment method according to claim 1, further comprising
at least one heat exchange step X1 allowing heat to be recovered from stream M3 to at least partially heat the water to be injected in step b), a cooled stream M3′ then being obtained, and optionally comprising at least one additional water heating step, downstream of the heat exchange X1 allowing the water to be heated to the temperature of at least 374° C. prior to its injection in step b); and
optionally at least one heat exchange step X2 to recover heat from stream M3′ to heat mixture M1p upstream of the injection of water in step b), a cooled stream M3″ then being obtained.

5. The hydrotreatment method according to claim 4, further comprising:
cooling at least one fraction of stream M3′ or where applicable stream M3″ to obtain steam and stream M4 comprising hydrotreated organic material; and
injecting at least part of said steam to preheat mixture M1 upstream of pressurization step a).

6. The hydrotreatment method according to claim 1, wherein mixture M1 is preheated upstream of pressurization step a) to a temperature ranging from 50 to 160° C.

7. The hydrotreatment method according to claim 5, wherein the cooling of at least one fraction of stream M3′ or where applicable of at least one fraction of stream M3″ is carried out at a regulated pressure based on the preheating temperature of mixture M1 upstream of pressurization step a).

8. The hydrotreatment method according to claim 5, further comprising cooling at least one fraction of stream M4 to obtain a stream M4′ and at least one digestion step carried out on at least one fraction of stream M4′.

9. The hydrotreatment method according to claim 1, wherein mixture M1p during the injection of water in step b) is at a temperature ranging from 90° C. to 300° C.

10. The hydrotreatment method according to claim 1, further comprising injecting water at a temperature of at least 374° C. directly into the hydrotreatment reactor.

11. The hydrotreatment method according to claim 1, wherein stream M3 comprising hydrotreated organic material is recovered via an outlet in an upper part of the reactor, said reactor further comprising an outlet in the lower part of the reactor.

12. The hydrotreatment method according to claim 1, wherein stream M3 comprising hydrotreated organic material exiting the reactor can undergo one or more further post-treatment steps, said further step(s) being implemented where applicable upstream of heat exchanges X1 and X2.

13. An installation suitable for implementing the hydrotreatment method according to any one of claim 1, said installation comprising:
a feed line for mixture M1;
a pressurization pump supplied by the feed line for mixture M1 and comprising an outlet line for mixture M1p;
a device for injecting water ES at an angle ranging from 15° to 90° into the line of mixture M1p downstream of the pressurization pump;
a feed line for stream M2 downstream of the water injection device ES and upstream of the hydrotreatment reactor; and
a hydrotreatment reactor comprising at least one inlet for introducing at least one fraction of stream M2 and at least one outlet for extracting stream M3.

14. The installation according to claim 13, further comprising:
a static turbulator supplied by stream M2, said static turbulator being located upstream or at the inlet of the hydrotreatment reactor; and
a heat exchanger downstream of the hydrotreatment reactor (1), said heat exchanger recovering heat from stream M3 to obtain stream M3′ and transferring this heat to the water upstream of the water injection device ES; and
optionally a water heating device, downstream of the heat exchanger and upstream of the water injection device ES.

15. The installation according to claim 13, further comprising:
optionally a heat exchanger for recovering heat from mixture M3′ to obtain mixture M3″ and for transferring this heat to mixture M1p upstream of the water injection device ES;
cooling device supplied by at least one fraction of stream M3′ or where applicable M3″ to produce steam and a cooled stream M4;
device for injecting said produced steam into the stream of mixture M1 upstream of the pressurization pump;
optionally a cooling device downstream of the cooling device supplied by at least one fraction of stream M4 for cooling at least one fraction of stream M4 to obtain stream M4′; and
optionally a digester supplied by stream M4′.
